(19) United States
(12) Patent Application Publication
(10) Pub. No.: US 2026/0032489 A1
(43) Pub. Date: Jan. 29, 2026

(54) METHOD AND APPARATUS FOR RECEIVING MEASUREMENT CONFIGURATION INFORMATION, DEVICE, AND READABLE STORAGE MEDIUM

(71) Applicant: Beijing Xiaomi Mobile Software Co., Ltd., Beijing (CN)

(72) Inventor: Xuhua TAO, Beijing (CN)

(73) Assignee: Beijing Xiaomi Mobile Software Co., Ltd., Beijing (CN)

(21) Appl. No.: 18/997,348

(22) PCT Filed: Aug. 8, 2022
(86) PCT No.: PCT/CN2022/110930

§ 371 Date: Jan. 21, 2025

(51) Int. Cl. H04W 24/10; H04W 24/08

(52) U.S. Cl. CPC H04W 24/10; H04W 24/08

(57) ABSTRACT

A method for receiving measurement configuration information, performed by user equipment, includes: receiving measurement configuration information sent by a network device, wherein the measurement configuration information is used for indicating reference information of configured carriers, and the reference information comprises a measurement priority and a signal strength threshold; and determining a first carrier to be measured from the configured carriers according to the reference information, and performing measurement on the first carrier to be measured to determine a second carrier to be measured with a signal strength that satisfies the signal strength threshold.

### CROSS REFERENCE TO RELATED APPLICATIONS

The present application is a U.S. National Stage of International Application No. PCT/CN2022/110930, filed on Aug. 8, 2022, all contents of which are incorporated herein by reference in their entireties for all purposes.

### TECHNICAL FIELD

The present disc relates to wireless communication technologies, and in particular, to a method and apparatus for receiving measurement configuration information, and a readable storage medium.

### BACKGROUND

In a current protocol for the new radio (NR) technology, in order to support fast establishment of Dual-Connectivity (DC) or Carrier Aggregation (CA) Connectivity, the measurement report of Early Measurement Report (EMR) is introduced; that is, user equipment may perform measurement and report in an idle state or an inactive state according to carrier measurement information configured by the network device.

### SUMMARY

According to a first aspect, there is provided a method for receiving measurement configuration information, performed by user equipment, and the method includes:
receiving measurement configuration information sent by a network device, where the measurement configuration information is used for indicating reference information of configured carriers, and the reference information includes a measurement priority and a signal strength threshold; and
determining a first carrier to be measured from the configured carriers according to the reference information, and performing measurement on the first carrier to be measured to determine a second carrier to be measured with a signal strength that satisfies the signal strength threshold.

According to a second aspect, there is provided a method for receiving measurement configuration information, performed by user equipment, and the method includes:
receiving capability requirement information sent by a network device, where the capability requirement information is used for indicating the user equipment to activate an enhanced EMR carrier measurement delay requirement; where, according to the enhanced EMR carrier measurement delay requirement, the user equipment is able to perform steps of: receiving measurement configuration information sent by the network device, wherein the measurement configuration information is used for indicating reference information of configured carriers, and the reference information comprises a measurement priority and a signal strength threshold; and determining a first carrier to be measured from the configured carriers according to the reference information, and performing measurement on the first carrier to be measured to determine a second carrier to be measured with a signal strength that satisfies the signal strength threshold.

According to a third aspect, there is provided a communication apparatus, including a processor and a memory, where the memory is configured to store a computer program, and the processor is configured to execute the computer program to implement the first aspect or any one of the possible designs of the first aspect.

According to a fourth aspect, there is provided a communication apparatus, including a processor and a memory, where the memory is configured to store a computer program, and the processor is configured to execute the computer program to implement the second aspect or any one of the possible designs of the second aspect.

According to a fifth aspect, there is provided a non-transitory computer-readable storage medium, where the computer-readable storage medium stores an instruction (a computer program, or a program), and when the instruction (the computer program, or the program) is invoked and executed on a computer, the computer is caused to perform the first aspect or any one of the possible designs of the first aspect.

According to an sixth aspect, there is provided a non-transitory computer-readable storage medium, where the computer-readable storage medium stores an instruction (a computer program, or a program), and when the instruction (the computer program, or the program) is invoked and executed on a computer, the computer is caused to perform the second aspect or any one of the possible designs of the second aspect.

It is to be understood that both the foregoing general description and the following detailed description are exemplary and explanatory only and are not restrictions of the present disclosure.

### BRIEF DESCRIPTION OF THE DRAWINGS

The accompanying drawings described here are used to provide a further understanding of the embodiments of the present disclosure, and constitute a part of the present disclosure. The illustrative embodiments of the embodiments of the present disclosure and the description of the embodiments of the present disclosure are used to explain the embodiments of the present disclosure, and do not constitute an improper limitation on the embodiments of the present disclosure.

The accompanying drawings here, which are incorporated in and constitute a part of the description, illustrate embodiments consistent with the embodiments of the present disclosure and, together with the description, serve to explain the principles of the embodiments of the present disclosure.

FIG. 1 is a schematic architectural diagram of a wireless communication system provided according to some embodiments of the present disclosure;

FIG. 2 is a flowchart of a method for receiving measurement configuration information shown according to some embodiments of the present disclosure;

FIG. 3 is a flowchart of a method for receiving measurement configuration information shown according to some embodiments of the present disclosure;

FIG. 4 is a structural diagram of an apparatus for receiving measurement configuration information shown according to some embodiments of the present disclosure;

FIG. 5 is a structural diagram of an apparatus for receiving measurement configuration information shown according to some embodiments of the present disclosure;

FIG. 6 is a structural diagram of an apparatus for receiving measurement configuration information shown according to some embodiments of the present disclosure.

### DETAILED DESCRIPTION

The embodiments of the present disclosure are further described with reference to the accompanying drawings and specific implementations here.

The examples embodiments will be described in detail here, with examples shown in the accompanying drawings. The following description refers to the accompanying drawings in which the same numbers in different drawings represent the same or similar elements unless otherwise represented. The implementations described in the following example embodiments do not represent all implementations consistent with the embodiments of the present disclosure. Instead, they are merely examples of apparatuses and methods consistent with some aspects of the present disclosure as detailed in the appended claims.

The terms used in the embodiments of the present disclosure are merely for the purpose of describing particular embodiments, and are not intended to limit the embodiments of the present disclosure. The singular forms “a” and “the” used in the embodiments of the present disclosure and the appended claims are also intended to include plural forms, unless the context clearly indicates other meanings. It should also be understood that the term “and/or” as used here refers to and includes any or all possible combinations of one or more associated listed items.

It should be understood that although the terms first, second, third, etc., may be used in the embodiments of the present disclosure to describe various information, these information should not be limited to these terms. These terms are only used to distinguish the same type of information from each other. For example, without departing from the scope of the embodiments of the present disclosure, the first information may also be referred to as second information; and similarly, the second information may also be referred to as first information. Depending on the context, the words “if” and “in case” as used here may be interpreted as “at the time . . . ” or “when . . . ” or “in response to determining . . . ”.

Embodiments of the present disclosure are described in detail below, and examples of the embodiments are shown in the accompanying drawings, in which the same or similar reference numerals refer to the same or similar elements throughout. The embodiments described below with reference to the drawings are examples, and are intended to explain the present disclosure, which are not to be construed as limitations of the present disclosure.

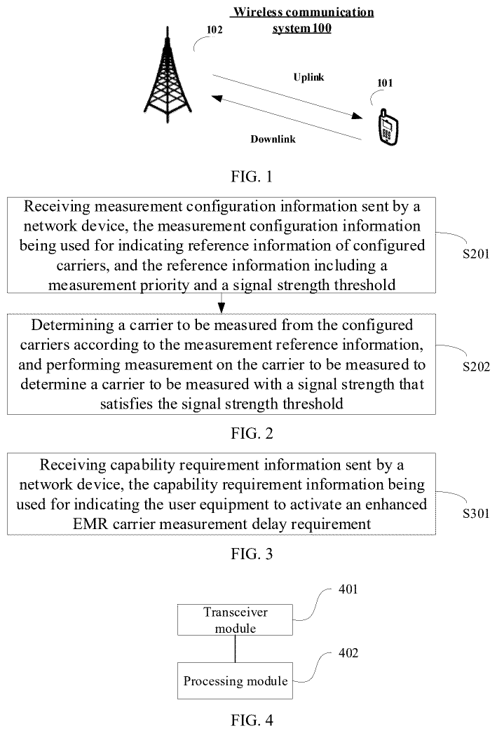

As shown in FIG. 1, the method for receiving measurement configuration information provided according to an embodiment of the present disclosure may be applied to a wireless communication system 100. The wireless communication system may include but is not limited to a network device 101 and user equipment 102. The user equipment 102 is configured to support carrier aggregation. The user equipment 102 may be connected to a plurality of carrier units of the network device 101, and the plurality of carrier units includes one primary carrier unit and one or more secondary carrier units.

It should be understood that the wireless communication system 100 may be applied to a low-frequency scenario or a high-frequency scenario. The application scenario of the wireless communication system 100 includes but is not limited to a long term evolution (LTE) system, an LTE frequency division duplex (FDD) system, an LTE time division duplex (TDD) system, a worldwide interoperability for micro wave access (WiMAX) communication system, a cloud radio access network (CRAN) system, a future 5th-generation (5G) system, a new radio (NR) communication system, or a future evolved public land mobile network (PLMN) system, etc.

The user equipment 102 shown above may be user equipment (UE), a terminal, an access terminal, a terminal unit, a terminal station, a mobile station (MS), a remote station, a remote terminal, a mobile terminal, a wireless communication device, a terminal agent, a user device, or the like. The user equipment 102 may have a wireless transceiver function, and may perform communication (for example, wireless communication) with one or more network devices 101 in one or more communication systems and accept the network service provided by the network device 101, where the network device 101 includes but is not limited to an base station illustrated in the figure.

In some embodiments, the user equipment 102 may be a cellular telephone, a cordless telephone, a session initiation protocol (SIP) phone, a wireless local loop (WLL) station, a personal digital assistant (PDA) device, a handheld device having a wireless communication function, a computing device, or another processing device connected to a wireless modem, a vehicle-mounted device, a wearable device, user equipment in a future 5G network, or user equipment in a future evolved PLMN network, etc.

The network device 101 may be an access network device (or referred to as an access network station), where the access network device refers to a device that has a function of providing a network access, such as a radio access network (RAN) base station, etc. The network device may include a base station (BS) device, or includes a base station device and a radio resource management device configured to control the base station device, etc. The network device may further include a relay station (a relay device), an access point, a base station in a future 5G network, a base station in a future evolved PLMN network, an NR base station, etc. The network device may be a wearable device or a vehicle-mounted device. The network device may alternatively be a communication chip having a communication module.

For example, the network device 101 includes but is not limited to: a next generation base station (gnodeB, gNB) in 5G, an evolved node B (eNB) in a LTE system, a radio network controller (RNC), a node B (NB) in a WCDMA system, a wireless controller or base station controller (BSC) in a CRAN system, a base transceiver station (BTS) in a GSM system or CDMA system, a home base station (such as a home evolved nodeB or a home nodeB, HNB), a baseband unit (BBU), a transmitting and receiving point (TRP), a transmitting point (TP), or a mobile switching center, etc.

In a current protocol for the new radio (NR) technology, in order to support fast establishment of Dual-Connectivity (DC) or Carrier Aggregation (CA) Connectivity, the Early Measurement Report (EMR) measurement report is introduced; that is, user equipment may perform measurement and report in an idle state or an inactive state according to carrier measurement information configured by the network device. According to the communication protocol requirement, the delay of performing detection and measurement on an FR2 (Frequency Range 2) carrier in an FR2 scenario is very long, and the delay will be further increased when considering the carrier number spreading factor. The inventor finds in the research that such a long latency requirement may result in an untrusted EMR measurement report result.

Therefore, the inventor finds in research that the measurement delay requirement needs to be enhanced, so as to avoid the situation of an untrusted EMR measurement report result that may be caused by a long delay requirement.

According to an embodiment of the present disclosure, there is provided a method for receiving measurement configuration information, performed by user equipment. FIG. 2 is a flowchart of a method for receiving measurement configuration information shown according to some embodiments of the present disclosure. As shown in FIG. 2, the method includes steps S201 to S202.

In step S201, measurement configuration information sent by a network device is received, where the measurement configuration information is used for indicating reference information of configured carriers, and the reference information includes a measurement priority and a signal strength threshold of a configured carrier.

In step S202, a carrier to be measured is determined from the configured carriers according to the reference information, and measurement is performed on the carrier to be measured to determine a carrier to be measured with a signal strength that satisfies a signal strength threshold.

The method for determining the carrier to be measured according to the correspondence between the reference information and the configured carriers may be performed according to one of the following three manners.

In the first manner:

The measurement configuration information is used for indicating a plurality of pieces of reference information, and the plurality of pieces of reference information are in one-to-one correspondence with a plurality of configured carriers. That is, each configured carrier corresponds to a measurement priority and a signal strength threshold of the configured carrier.

A carrier to be measured is determined according to the measurement priority, and measurement is performed on the carrier to be measured to determine a carrier to be measured with a signal strength that satisfies the signal strength threshold. In an example, the following is performed to determine the carrier to be measured with a signal strength that is greater than or equal to the signal strength threshold corresponding to the carrier to be measured by performing measurement on the carrier to be measured: selecting a configured carrier with a highest measurement priority from the unmeasured configured carriers as the carrier to be measured, and further performing measurement on the selected carrier to be measured to determine the carrier to be measured with a signal strength that is greater than or equal to the signal strength threshold.

In an example:

The configured carriers include an NR carrier list and an LTE carrier list, where the NR carrier list includes X NR carriers, and the LTE carrier list includes Y LTE carriers.

In the measurement configuration information, the reference information used for indicating the configured carriers includes that:
the measurement priorities of the X NR carriers are 1, 2, 3, . . . , and X in sequence;
the signal strength thresholds of the X NR carriers are thres(1), thres(2), thres(3), . . . , and thres (x) in sequence;
the measurement priorities of the Y LTE carriers are X+1, X+2, X+3, . . . , and X+Y in sequence; and
the signal strength thresholds of the Y LTE carriers are thres (X+1), thres (X+2), thres (X+3), . . . , and thres (X+Y) in sequence.

In a possible implementation, measurement priorities of all NR carriers are greater than measurement priorities of all LTE carriers. In a possible implementation, the smaller the value of the measurement priority of the configured carrier, the higher the measurement priority; that is, the measurement priority of a carrier with a measurement priority of 1 is higher than the measurement priority of a carrier with a measurement priority of 2, and the measurement priority of a LTE carrier with a measurement priority of X+1 is higher than the measurement priority of a LTE carrier with a measurement priority of X+2. In a possible implementation, the carrier to be measured may also be screened according to other conditions in addition to the measurement priority, which is not limited in the embodiments of the present disclosure.

In the foregoing embodiments, for example, each carrier to be measured may correspond to one signal strength threshold. Certainly, a plurality of carriers to be measured may also correspond to one signal strength threshold; that is, the values of any two of thres(1), thres(2), thres(3), . . . , and thres (X) may be the same or different, and the values of any two of thres (X+1), thres (X+2), thres (X+3), . . . , and thres (X+Y) may be the same or different, which is not limited in the embodiments of the present disclosure.

For example, when none of the carriers in the configured carriers is measured, the configured carrier with the highest measurement priority is selected as the carrier to be measured. That is, the NR carrier with the measurement priority of 1 is selected as the carrier to be measured; measurement is performed on the carrier to be measured to obtain a measurement result res1; it is determined whether the measurement result res1 is greater than or equal to the signal strength threshold thres(1) of the NR carrier with the measurement priority of 1; when res1≥thres(1), the measurement result res1 of the NR carrier with the measurement priority of 1 is reported; and, it is ended.

When res1<thres (1), it is continued to select the carrier with the highest measurement priority from the remaining configured carriers as the carrier to be measured. That is, the NR carrier with the measurement priority of 2 is selected as the carrier to be measured; measurement is performed on the carrier to be measured to obtain a measurement result res2; it is determined whether the measurement result res2 is greater than or equal to the signal strength threshold thres(2) of the NR carrier with the measurement priority of 2; when res2≥thres (2), the measurement result res2 of the NR carrier with the measurement priority of 2 is reported; and, it is ended.

when res2<thres(2), the carrier to be measured is re-selected, and so on, until the measurement result of the carrier to be measured is greater than or equal to the signal strength threshold corresponding to the carrier, and the measurement result of the carrier to be measured is reported.

In the second manner:

The measurement configuration information is used for indicating configuration information of N groups, each group of the N groups corresponds to at least one piece of reference information, each piece of reference information corresponds to a configured carrier, the configured carrier corresponding to the reference information in the same group belong to the same network, and N is an integer greater than 1.

A configured carrier with the highest measurement priority is selected from the configured carrier in each group of the N groups as the carrier to be measured for measurement, and a carrier to be measured with a signal strength that satisfies a signal strength threshold is determined respectively from each group of the N groups.

In some embodiments, the following is repeatedly performed until the N signal strengths obtained by performing measurement on the selected N carriers to be measured are all greater than or equal to the corresponding signal strength thresholds: selecting a configured carrier with the highest measurement priority from the configured carrier in each group other than the configured carrier that has been determined to be with a signal strength less than the corresponding signal strength threshold as the N carriers to be measured, and further performing measurement on the selected N carriers to be measured to determine a carrier to be measured with a signal strength that is greater than the signal strength threshold from the carrier to be measured.

In an example:

The configured carriers include an NR carrier list and an LTE carrier list, where the NR carrier list includes X NR carriers, the LTE carrier list includes Y LTE carriers, and two groups are determined. The configured carriers in the same group belong to the same network, all NR carriers are determined as a group, and all the LTE carriers are determined as a group.

The measurement configuration information is used for indicating configuration information of each group of configured carriers, and each group of configured carriers includes at least one piece of reference information.

Each group corresponds to a set of measurement priorities and a set of signal strength thresholds.

The measurement priorities of the X NR carriers are A-1, A-2, A-3, . . . , and A-X in sequence.

The signal strength thresholds of the X NR carriers are thres-1, thres-2, thres-3, . . . , and thres-X in sequence.

The measurement priorities of the Y LTE carriers are B-1, B-2, B-3, . . . , and B-Y in sequence.

The signal strength thresholds of the Y LTE carriers are THRE-1, THRE-2, THRE-3, . . . , and THRE-Y in sequence.

Therefore, the carrier measurement priorities and the signal strength thresholds in each group of configured carriers may be obtained.

The smaller the number in the measurement priority of the configured carrier, the higher the measurement priority. That is, the measurement priority of the NR carrier with a measurement priority of A-1 is higher than the measurement priority of the NR carrier with a measurement priority of A-2, and the measurement priority of the LTE carrier with a measurement priority of B-1 is higher than the measurement priority of the LTE carrier with a measurement priority of B-2.

All carriers in each group have not been measured, and the configuration carrier with the highest measurement priority is selected respectively from each group as the carrier to be measured. That is, the NR carrier with the measurement priority of A-1 and the LTE carrier with the measurement priority of B-1 are selected as the carriers to be measured; measurement is performed on the carriers to be measured to obtain a measurement result resA-1 and a measurement result resB-1; it is determined whether the measurement result resA-1 is greater than or equal to the signal strength threshold thre-1 of the NR carrier with the measurement priority of A-1, and whether the measurement result resB-1 is greater than or equal to the signal strength threshold THRE-1 of the LTE carrier with the measurement priority of B-1; when resA-1≥thres-1 and resB-1≥THRE-1, the measurement result resA-1 and the measurement result resB-1 are reported; and, it is ended.

When resA-1<thres-1 and resB-1<THRE-1, it is continued to select the carrier with the highest measurement priority from the configured carrier in each group other than the configured carrier that has been determined to be with a signal strength less than the corresponding signal strength threshold as the carrier to be measured. That is, the NR carrier with the measurement priority of A-2 and the LTE carrier with the measurement priority of B-2 are selected as the carriers to be measured; measurement is performed on the carriers to be measured to obtain a measurement result resA-2 and a measurement result resB-2; it is determined whether the measurement result resA-2 is greater than or equal to the signal strength threshold thres-2 of the NR carrier with the measurement priority of A2, and whether the measurement result resB-2 is greater than or equal to the signal strength threshold THRE-2 of the LTE carrier with the measurement priority of B-2; when resA-2≥thres-2 and resB-2<THRE-2, the measurement result resA-2 and the measurement result resB-2 are reported; and, it is ended.

When resA-2<thres-2 and resB-2<THRE-2, the carrier to be measured is re-selected from the unmeasured configured carriers in each group, and so on, until each measurement result of the selected carrier to be measured from each group is greater than or equal to the signal strength threshold corresponding to the carrier, and the measurement result of the carrier to be measured is reported.

When resA-1<thres-1 or resB-1<THRE-1, that is to say, when only the carrier to be measured in one group does not satisfy the signal strength threshold, the remaining unmeasured configuration carriers in the group corresponding to the carrier to be measured not satisfying the signal strength threshold are re-determined, from which the carrier with the highest measurement priority is selected as the carrier to be measured; and then, measurement is performed.

In the foregoing embodiment, for example, each carrier to be measured may correspond to one signal strength threshold. Certainly, a plurality of carriers to be measured may also correspond to one signal strength threshold; that is, the values of any two of thres-1, thres-2, thres-3, . . . , and thres-X may be the same or different, and the values of any two of THRE-1, THRE-2, THRE-3, . . . , and THRE-Y may be the same or different, which is not limited in the embodiments of the present disclosure.

In some embodiments, measurement priorities of all NR carriers are greater than measurement priorities of all LTE carriers.

In the third manner:

The measurement configuration information is used for indicating configuration information of M groups, each group corresponds to one piece of reference information, each group corresponds to at least one configured carrier, and M is an integer greater than 1.

The following content is repeatedly performed until signal strengths obtained by performing measurement on all carriers to be measured in the selected groups are all greater than or equal to the signal strength thresholds corresponding to the selected groups: selecting a group corresponding to the highest measurement priority from the groups corresponding to the unmeasured and selected configured carriers, taking all configured carriers corresponding to the selected group as the carriers to be measured, and further performing measurement on the carriers to be measured to determine a carrier to be measured with a signal strength that is greater than the signal strength threshold from the carriers to be measured.

In an example:

The configured carriers include an NR carrier list and an LTE carrier list, where the NR carrier list includes X NR carriers, the LTE carrier list includes Y LTE carriers. All NR carriers and all LTE carriers are grouped into M groups (M>1), and each group includes at least one configured carrier. The measurement configuration information is used for indicating configuration information of the M groups, and each group corresponds to one piece of reference information. That is, all configured carriers in each group correspond to one measurement priority and one signal strength threshold. In the embodiments of the present disclosure, the number of carriers in each group may be the same as or different from each other. Each group may include only NR carriers, or may include only LTE carriers, or may include an NR carrier and an LTE carrier simultaneously.

The measurement priorities of the M groups of carriers are 1, 2, 3, . . . , and M in sequence. The signal strength thresholds of M groups of carriers are thres1, thres2, thres3, . . . , and thresM in sequence.

The smaller the number in the measurement priority of the group of the configured carriers, the higher the measurement priority. That is, the measurement priority of the group of carriers with the measurement priority of 1 is higher than the measurement priority of the group of carriers with the measurement priority of 2.

When none of the groups of carriers is measured, all the configured carriers in the group of carriers with the highest priority are taken as the carriers to be measured; that is, all the configured carriers in the group of carriers with the priority of 1 are taken as the carriers to be measured. Measurement is performed on the carriers to be measured to obtain the measurement results of all the configured carriers. It is determined whether the measurement results are all greater than or equal to the signal strength threshold thres1 of the group of carriers with the measurement priority of 1. When the measurement results of all the carriers to be measured are greater than or equal to thres1, the measurement results are reported, and it is ended.

When there is a configured carrier with a measurement result being less than thres1 in the group of carriers with the measurement priority of 1, it is continued to select the group of carriers with the highest measurement priority from the remaining unmeasured groups of carriers, all the configured carriers in which are taken as carriers to be measured. That is, all the configured carriers in the group of carriers with the priority of 2 are taken as the carriers to be measured. Measurement is performed on the carriers to be measured to obtain the measurement results of all the configured carriers. It is determined whether the measurement results are all greater than or equal to the signal strength threshold thres2 of the group of carriers with the measurement priority of 2. When the measurement results of all the carriers to be measured are greater than or equal to thres2, the measurement results are reported.

When there is a configured carrier with a measurement result being less than thres2 in the group of carriers with the measurement priority of 2, the group of carriers is re-selected to determine the carriers to be measured, and so on, until the measurement results of all the carriers to be measured in the group of carriers are greater than or equal to the signal strength threshold corresponding to the group of carriers, and the measurement results are reported.

The three manners of implementations provided in the present disclosure may be implemented independently or combined together, which is not limited in the embodiments of the present disclosure.

In the embodiments of the present disclosure, the user equipment obtains the measurement priority and the signal strength threshold of the carrier to be measured through the measurement configuration information, and the number of carriers to be measured ma y be reduced according to the measurement priority and the signal strength threshold of the carrier to be measured, thus achieving the effect of shortening the delay of the carrier detection and measurement.

In the foregoing embodiment, the signal strength threshold corresponding to the carrier to be measured may be, for example, specified by the network side device. Of course, it may also be determined by a communication protocol, in which the steps are the same as those in the foregoing embodiments, and the reference information may not include the signal strength threshold, and details are not described here again. In some embodiments, measurement may be performed on the carrier to be measured according to the measurement priority, and a carrier to be measured with a signal strength being greater than or equal to the signal strength threshold is determined. In the embodiments of the present disclosure, for example, the network device may indicate the reference information by using an information element (IE) MeasIdleConfig, where the reference information may include the measurement priority of the configured carrier; and the user equipment may determine the signal strength threshold through the communication protocol. Alternatively, the network device may indicate the reference information by using the information element (IE) MeasIdleConfig, where the reference information may include the measurement priority and the signal strength threshold of the configured carrier; and the user equipment may determine the measurement priority and the signal strength threshold of the configured carrier through the communication protocol.

According to an embodiment of the present disclosure, there is provided a method for receiving measurement configuration information, performed by user equipment. FIG. 3 is a flowchart of a method for receiving measurement configuration information according to some embodiments of the present disclosure. As shown in FIG. 3, the method includes step S301.

In step S301, capability requirement information sent by a network device is received, where the capability requirement information is used for indicating the user equipment to activate an enhanced EMR carrier measurement delay requirement.

In some embodiments, the user equipment is UE supporting a capability of a plurality of receiving beam (Rx Beam) (simultaneousReceptionDiffTypeD-r16 capability).

In an example, the network device sends capability requirement information to the user equipment by using radio resource control (RRC) signaling.

In some embodiments, the enhanced EMR carrier measurement delay requirement includes at least one of the following:
a measurement delay requirement for inter-frequency cells (inter-frequency CA/DC candidate cells) measurement; or
a measurement delay requirement for inter-system cells (inter-RAT E-UTRAN DC candidate cells).

In the embodiments of the present disclosure, the user equipment activates the enhanced EMR carrier measurement delay requirement through the indication information of the network device, to achieve the effect of reducing the carrier measurement delay. It should be noted that, the “enhanced EMR carrier measurement delay requirement” refers to that the UE is able to perform the method including step 201 to step 202. That is, the network side device activates the UE through step 301, so that the UE performs the method including step 201 to step 202 during carrier measurement.

Those skilled in the art may understand that step 301 may be implemented separately, or may be implemented with step 201 and step 202.

For example, in the technical solution of the present disclosure, the carrier measurement delay is reduced by configuring the measurement priority of the carrier to be measured and the signal strength threshold of the carrier to be measured.

In example 1, the network configures the measurement configuration information of the NR carrier list (A NR carriers) and the LTE carrier list (B LTE carriers) through IE MeasIdleConfig, and each carrier to be measured is indicated with a carrier measurement priority (the measurement priorities being 1 to (A+B) from high to low) and a corresponding threshold (the thresholds being thres 1 to thres (A+B)). The UE initially only performs measurement on the carrier with the highest carrier measurement priority (the carrier corresponding to the carrier measurement priority 1). If the signal strength of the carrier is lower than the corresponding threshold thres1, the UE starts to perform measurement on the carrier corresponding to the carrier measurement priority 2, and so on.

In example 2, the network configures the measurement configuration information of the NR carrier list (A NR carriers) and the LTE carrier list (B LTE carriers) through IE MeasIdleConfig, and the NR carriers to be measured and the LTE carriers to be measured are indicated with carrier measurement priorities (the measurement priorities of NR carriers being 1A to AA from high to low, and the measurement priorities of LTE carriers being 1B to BB from high to low) and corresponding thresholds (the thresholds being thres1A to thresAA and thres1B to thresBB), respectively. The UE initially only performs measurement on the NR carrier with the highest carrier measurement priority and the LTE carrier with the highest carrier measurement priority (the carriers corresponding to the carrier measurement priorities 1A and 1B). If the signal strength of the NR carrier is lower than the corresponding threshold thres 1A or the signal strength of the LTE carrier is lower than the corresponding threshold thres1B, the UE starts to perform measurement on the carrier corresponding to the NR carrier with the carrier measurement priority 2A or the LTE carrier with the measurement priority 2B, and so on.

In example 3, the network side device configures measurement configuration information of the NR carrier list (A NR carriers) and the LTE carrier list (B LTE carriers) through IF MeasIdleConfig. The carriers to be measured are divided into N groups, each group has at least one carrier to be measured, and each group of carriers is indicated with a carrier group measurement priority (the measurement priorities being 1 to N from high to low) and a corresponding carrier group threshold (the thresholds being thres1 to thresN). The UE initially only performs measurement on the carriers in the group of carries with the highest carrier group measurement priority (the group of carriers corresponding to the carrier group measurement priority 1). If the signal strengths of all carriers in the group of carriers are lower than the threshold thres 1 of the group of carriers, the UE starts to perform measurement on the carriers in the group of carriers corresponding to the carrier group measurement priority 2, and so on.

Based on the same concept as the foregoing method embodiments, there is further provided a communication apparatus according to an embodiment of the present disclosure, where the communication apparatus may have the functions of the user equipment 102 in the foregoing method embodiments, and is configured to perform the steps performed by the user equipment 102 provided in the foregoing embodiments. The functions may be implemented by hardware, or may be implemented by software or hardware by executing corresponding software. The hardware or the software includes one or more modules corresponding to the foregoing functions.

In a possible implementation, the communication apparatus 400 shown in FIG. 4 may be used as the user equipment 102 in the foregoing method embodiments, and perform the steps performed by the user equipment 102 in the foregoing method embodiments.

The communication apparatus 400 includes a transceiver module 401 and a processing module 402.

The transceiver module 401 is configured to receive measurement configuration information sent by a network device, where the measurement configuration information is used for indicating reference information of configured carriers, and the reference information includes a measurement priority and a signal strength threshold.

The processing module 402 is configured to determine a carrier to be measured from the configured carriers according to the reference information; and perform measurement on the carrier to be measured to determine a carrier to be measured with a signal strength that satisfies the signal strength threshold.

In some embodiments, the measurement configuration information is used for indicating a plurality of pieces of reference information, and the reference information is in one-to-one correspondence with the configured carriers.

The processing module 402 is further configured to determine the carrier to be measured according to the measurement priority, and perform measurement on the carrier to be measured to determine a carrier to be measured with a signal strength that satisfies the signal strength threshold.

In some embodiments, the measurement configuration information is used for indicating configuration information of N groups, where each group of the N groups corresponds to at least one piece of reference information, each piece of reference information corresponds to a configured carrier, configured carriers corresponding to reference information in the same group belong to the same network, and N is an integer greater than 1.

The processing module 402 is further configured to select a configured carrier with a highest measurement priority respectively from the configured carriers in each group of the N groups as the carrier to be measured for measurement, to determine a carrier to be measured with a signal strength that satisfies a signal strength threshold respectively from each group of the N groups.

In some embodiments, the measurement configuration information is used for indicating configuration information of M groups, and the reference information includes a measurement priority and a signal strength threshold corresponding to a group. Each group corresponds to one piece of reference information, each group corresponds to at least one configured carrier, and Mis an integer greater than 1.

The processing module 402 is further configured to: determine all groups that includes an unmeasured configured carrier, determine a group with a highest measurement priority, take all configured carriers in the group as carriers to be measured, and perform measurement on the carriers to be measured to determine the carrier to be measured with signal strength that satisfies the signal strength threshold.

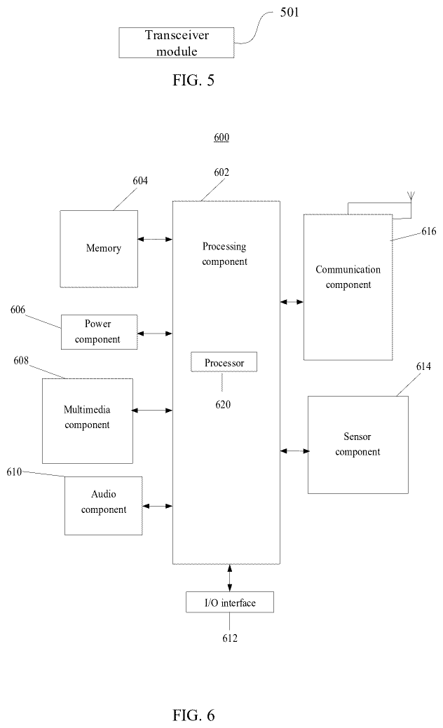

In a possible implementation, the communication apparatus 500 shown in FIG. 5 may be used as the user equipment 102 in the foregoing method embodiments, and perform the steps performed by the user equipment 102 in the foregoing method embodiments.

The communication apparatus 500 includes a transceiver module 501.

The transceiver module 501 is configured to receive capability requirement information sent by a network device, where the capability requirement information is used for indicating the user equipment to activate an enhanced EMR carrier measurement delay requirement.

In some embodiments, the enhanced EMR carrier measurement delay requirement includes at least one of the following:
a measurement delay requirement for inter-frequency cells; or
a measurement delay requirement for inter-system cells.

When the communication apparatus is user equipment, the structure of the communication apparatus may also be shown in FIG. 6. FIG. 6 is a block diagram of an apparatus 600 for receiving measurement configuration information according to some embodiments of the present disclosure. For example, the apparatus 600 may be a mobile phone, a computer, a digital broadcast terminal, a message transceiver device, a game console, a tablet device, a medical device, an exercise device, a personal digital assistant, or the like.

Referring to FIG. 6, the apparatus 600 may include one or more of the following components: a processing component 602, a memory 604, a power component 606, a multimedia component 608, an audio component 610, an input/output (I/O) interface 612, a sensor component 614, and a communication component 616.

The processing component 602 generally controls overall operations of the apparatus 600, such as operations associated with display, telephone calls, data communications, camera operations, and recording operations. The processing component 602 may include one or more processors 620 to execute instructions to perform all or part of the steps of the above-described methods. Moreover, the processing component 602 may include one or more modules which facilitate the interaction between the processing component 602 and other components. For example, the processing component 602 may include a multimedia module to facilitate interaction between the multimedia component 608 and the processing component 602.

The memory 604 is configured to store various types of data to support the operation of the apparatus 600. Examples of such data include instructions for any application or method operating on apparatus 600, contact data, phonebook data, messages, pictures, videos, etc. The memory 604 may be implemented by any type of volatile or non-volatile storage device or a combination of them, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

The power component 606 provides power to various components of the apparatus 600. The power component 606 may include a power management system, one or more power supplies, and other components associated with generation, management, and distribution of power for the apparatus 600.

The multimedia component 608 includes a screen providing an output interface between the apparatus 600 and the user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touches, slides, and gestures on the touch panel. The touch sensor may not only sense a boundary of a touch or slide action, but also detect a duration and pressure associated with the touch or slide action. In some embodiments, the multimedia component 608 includes a front camera and/or a rear camera. The front camera and/or the rear camera may receive external multimedia data when the apparatus 600 is in an operation mode, such as a photographing mode or a video mode. Each of the front camera and the rear camera may be a fixed optical lens system or have focal length and optical zoom capability.

The audio component 610 is configured to output and/or input audio signals. For example, the audio component 610 includes a microphone (MIC) configured to receive an external audio signal when the apparatus 600 is in an operation mode, such as a call mode, a recording mode, and a speech recognition mode. The received audio signal may be further stored in the memory 604 or transmitted via the communication component 616. In some embodiments, the audio component 610 further includes a speaker to output audio signals.

The I/O interface 612 provides an interface between the processing component 602 and the peripheral interface module, which may be a keyboard, a click wheel, a button, or the like. The button may include, but are not limited to, a home button, a volume button, a starting button, and a locking button.

The sensor component 614 includes one or more sensors to provide status assessments of various aspects of the apparatus 600. For example, the sensor component 614 may detect an on/off state of the apparatus 600, relative positioning of the components, for example, the components being a display and a keypad of the apparatus 600. The sensor component 614 may also detect the position change of the apparatus 600 or a component of the apparatus 600, the presence or absence of contact by the user with the apparatus 600, the orientation or acceleration/deceleration of the apparatus 600, and the temperature change of the apparatus 600. The sensor component 614 may include a proximity sensor configured to detect the presence of nearby objects without any physical contact. The sensor component 614 may also include an optical sensor, such as a CMOS or CCD image sensor, for use in imaging applications. In some embodiments, the sensor component 614 may further include an acceleration sensor, a gyroscope sensor, a magnetic sensor, a pressure sensor, or a temperature sensor.

The communication component 616 is configured to facilitate wired or wireless communication between the apparatus 600 and other devices. The apparatus 600 may access a wireless network based on a communication standard, such as WiFi, 4G, or 5G, or a combination of them. In some embodiments, the communication component 616 receives a broadcast signal or broadcast associated information from an external broadcast management system via a broadcast channel. In some embodiments, the communication component 616 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In some embodiments, the apparatus 600 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components for performing the methods described above.

Other implementations of the embodiments of the present disclosure will be apparent to those skilled in the art from consideration of the description and practice of the present disclosure here. The present disclosure is intended to cover any variations, uses, or adaptations of the present disclosure following the general principles of the present disclosure and including common general knowledge and conventional technical means in the art not disclosed in the present disclosure. It is intended that the description and examples may be considered as exemplary only, with a true scope and spirit of the embodiments of the present disclosure being indicated by the following claims.

It should be understood that the embodiments of the present disclosure are not limited to the precise structures that have been described above and shown in the accompanying drawings, and various modifications and changes may be made without departing from the scope of the present disclosure. The scope of the embodiments of the present disclosure is limited only by the appended claims.

### INDUSTRIAL APPLICABILITY

The user equipment obtains the measurement priority and the signal strength threshold of the carrier to be measured through the measurement configuration information, and the number of carriers to be measured is reduced according to the measurement priority and the signal strength threshold of the carrier to be measured; or, by configuring the enhanced EMR carrier measurement delay requirement, the effect of shortening the carrier detection and measurement delay is achieved.

1. A method for receiving measurement configuration information, performed by user equipment, comprising:
receiving measurement configuration information sent by a network device, wherein the measurement configuration information is used for indicating reference information of configured carriers, and the reference information comprises a measurement priority and a signal strength threshold; and
determining a first carrier to be measured from the configured carriers according to the reference information, and performing measurement on the first carrier to be measured to determine a second carrier to be measured with a signal strength that satisfies the signal strength threshold.

2. The method according to claim 1, wherein,
the measurement configuration information is used for indicating a plurality of pieces of reference information, and the plurality pieces of reference information are in one-to-one correspondence with the configured carriers; and
determining the first carrier to be measured from the configured carriers according to the reference information, and performing measurement on the first carrier to be measured to determine the second carrier to be measured with the signal strength that satisfies the signal strength threshold, comprises:
determining the first carrier to be measured according to the measurement priority, and performing measurement on the first carrier to be measured to determine the second carrier to be measured with the signal strength that satisfies the signal strength threshold.

3. The method according to claim 1, wherein,
the measurement configuration information is used for indicating configuration information of N groups, wherein, each group of the N groups corresponds to at least one piece of reference information, each piece of reference information corresponds to a configured carrier, and configured carriers corresponding to reference information in a same group belong to a same network, and N is an integer greater than 1; and
determining the first carrier to be measured from the configured carriers according to the reference information, and performing measurement on the first carrier to be measured to determine the second carrier to be measured with the signal strength that satisfies the signal strength threshold, comprises:
selecting a configured carrier with a highest measurement priority respectively from the configured carriers in each group of the N groups as the first carrier to be measured for measurement, to determine a second carrier to be measured with a signal strength that satisfies a signal strength threshold respectively from each group of the N groups.

4. The method according to claim 1, wherein,
the measurement configuration information is used for indicating configuration information of M groups, each group corresponds to one piece of reference information, and the one piece of reference information comprises a measurement priority and a signal strength threshold corresponding to the group; each group corresponds to at least one configured carrier, and M is an integer greater than 1; and
determining the first carrier to be measured from the configured carriers according to the reference information, and performing measurement on the first carrier to be measured to determine the second carrier to be measured with the signal strength that satisfies the signal strength threshold, comprises:
determining all groups that comprise an unmeasured configured carrier, determining a group with a highest measurement priority, taking all configured carriers in the group as first carriers to be measured, and performing measurement on the first carriers to be measured to determine the second carrier to be measured with the signal strength that satisfies the signal strength threshold.

5. A method for receiving measurement configuration information, performed by user equipment, and comprising:
receiving capability requirement information sent by a network device, wherein the capability requirement information is used for indicating the user equipment to activate an enhanced EMR carrier measurement delay requirement;
wherein, according to the enhanced EMR carrier measurement delay requirement, the user equipment is able to perform steps of:
receiving measurement configuration information sent by the network device, wherein the measurement configuration information is used for indicating reference information of configured carriers, and the reference information comprises a measurement priority and a signal strength threshold; and
determining a first carrier to be measured from the configured carriers according to the reference information, and performing measurement on the first carrier to be measured to determine a second carrier to be measured with a signal strength that satisfies the signal strength threshold.

6. The method according to claim 5, wherein,
the enhanced EMR carrier measurement delay requirement comprises at least one of:
a measurement delay requirement for inter-frequency cells; or
a measurement delay requirement for inter-system cells.

7. (canceled)

8. A communication apparatus, comprising a processor and a memory, wherein,
the memory is configured to store a computer program; and
the processor is configured to execute the computer program to implement a method for receiving measurement configuration information, comprising:
receiving measurement configuration information sent by a network device, wherein the measurement configuration information is used for indicating reference information of configured carriers, and the reference information comprises a measurement priority and a signal strength threshold; and
determining a first carrier to be measured from the configured carriers according to the reference information, and performing measurement on the first carrier to be measured to determine a second carrier to be measured with a signal strength that satisfies the signal strength threshold.

9. A communication apparatus, comprising a processor and a memory, wherein,
the memory is configured to store a computer program; and
the processor is configured to execute the computer program to implement the method according to claim 5.

10. A non-transitory computer-readable storage medium, wherein an instruction is stored in the computer-readable storage medium, and when the instruction is invoked and executed on a computer, the computer is caused to perform the method according to claim 1.

11. A non-transitory computer-readable storage medium, wherein an instruction is stored in the computer-readable storage medium, and when the instruction is invoked and executed on a computer, the computer is caused to execute the method according to claim 5.

12. The method according to claim 5, wherein, the measurement configuration information is used for indicating a plurality of pieces of reference information, and the plurality pieces of reference information are in one-to-one correspondence with the configured carriers; and
determining the first carrier to be measured from the configured carriers according to the reference information, and performing measurement on the first carrier to be measured to determine the second carrier to be measured with the signal strength that satisfies the signal strength threshold, comprises:
determining the first carrier to be measured according to the measurement priority, and performing measurement on the first carrier to be measured to determine the second carrier to be measured with the signal strength that satisfies the signal strength threshold.

13. The method according to claim 5, wherein, the measurement configuration information is used for indicating configuration information of N groups, wherein, each group of the N groups corresponds to at least one piece of reference information, each piece of reference information corresponds to a configured carrier, and configured carriers corresponding to reference information in a same group belong to a same network, and N is an integer greater than 1; and
determining the first carrier to be measured from the configured carriers according to the reference information, and performing measurement on the first carrier to be measured to determine the second carrier to be measured with the signal strength that satisfies the signal strength threshold, comprises:
selecting a configured carrier with a highest measurement priority respectively from the configured carriers in each group of the N groups as the first carrier to be measured for measurement, to determine a second carrier to be measured with a signal strength that satisfies a signal strength threshold respectively from each group of the N groups.

14. The method according to claim 5, wherein, the measurement configuration information is used for indicating configuration information of M groups, each group corresponds to one piece of reference information, and the one piece of reference information comprises a measurement priority and a signal strength threshold corresponding to the group; each group corresponds to at least one configured carrier, and M is an integer greater than 1; and
determining the first carrier to be measured from the configured carriers according to the reference information, and performing measurement on the first carrier to be measured to determine the second carrier to be measured with the signal strength that satisfies the signal strength threshold, comprises:
determining all groups that comprise an unmeasured configured carrier, determining a group with a highest measurement priority, taking all configured carriers in the group as first carriers to be measured, and performing measurement on the first carriers to be measured to determine the second carrier to be measured with the signal strength that satisfies the signal strength threshold.

15. The communication apparatus according to claim 8, wherein, the measurement configuration information is used for indicating a plurality of pieces of reference information, and the plurality pieces of reference information are in one-to-one correspondence with the configured carriers; and
determining the first carrier to be measured from the configured carriers according to the reference information, and performing measurement on the first carrier to be measured to determine the second carrier to be measured with the signal strength that satisfies the signal strength threshold, comprises:
determining the first carrier to be measured according to the measurement priority, and performing measurement on the first carrier to be measured to determine the second carrier to be measured with the signal strength that satisfies the signal strength threshold.

16. The communication apparatus according to claim 8, wherein, the measurement configuration information is used for indicating configuration information of N groups, wherein, each group of the N groups corresponds to at least one piece of reference information, each piece of reference information corresponds to a configured carrier, and configured carriers corresponding to reference information in a same group belong to a same network, and N is an integer greater than 1; and
determining the first carrier to be measured from the configured carriers according to the reference information, and performing measurement on the first carrier to be measured to determine the second carrier to be measured with the signal strength that satisfies the signal strength threshold, comprises:
selecting a configured carrier with a highest measurement priority respectively from the configured carriers in each group of the N groups as the first carrier to be measured for measurement, to determine a second carrier to be measured with a signal strength that satisfies a signal strength threshold respectively from each group of the N groups.

17. The communication apparatus according to claim 8, wherein, the measurement configuration information is used for indicating configuration information of M groups, each group corresponds to one piece of reference information, and the one piece of reference information comprises a measurement priority and a signal strength threshold corresponding to the group; each group corresponds to at least one configured carrier, and M is an integer greater than 1; and
determining the first carrier to be measured from the configured carriers according to the reference information, and performing measurement on the first carrier to be measured to determine the second carrier to be measured with the signal strength that satisfies the signal strength threshold, comprises:
determining all groups that comprise an unmeasured configured carrier, determining a group with a highest measurement priority, taking all configured carriers in the group as first carriers to be measured, and performing measurement on the first carriers to be measured to determine the second carrier to be measured with the signal strength that satisfies the signal strength threshold.

18. The communication apparatus according to claim 9, wherein, the measurement configuration information is used for indicating a plurality of pieces of reference information, and the plurality pieces of reference information are in one-to-one correspondence with the configured carriers; and
determining the first carrier to be measured from the configured carriers according to the reference information, and performing measurement on the first carrier to be measured to determine the second carrier to be measured with the signal strength that satisfies the signal strength threshold, comprises:
determining the first carrier to be measured according to the measurement priority, and performing measurement on the first carrier to be measured to determine the second carrier to be measured with the signal strength that satisfies the signal strength threshold.

19. The communication apparatus according to claim 9, wherein, the measurement configuration information is used for indicating configuration information of N groups, wherein, each group of the N groups corresponds to at least one piece of reference information, each piece of reference information corresponds to a configured carrier, and configured carriers corresponding to reference information in a same group belong to a same network, and N is an integer greater than 1; and
determining the first carrier to be measured from the configured carriers according to the reference information, and performing measurement on the first carrier to be measured to determine the second carrier to be measured with the signal strength that satisfies the signal strength threshold, comprises:
selecting a configured carrier with a highest measurement priority respectively from the configured carriers in each group of the N groups as the first carrier to be measured for measurement, to determine a second carrier to be measured with a signal strength that satisfies a signal strength threshold respectively from each group of the N groups.

20. The communication apparatus according to claim 9, wherein, the measurement configuration information is used for indicating configuration information of M groups, each group corresponds to one piece of reference information, and the one piece of reference information comprises a measurement priority and a signal strength threshold corresponding to the group; each group corresponds to at least one configured carrier, and M is an integer greater than 1; and
determining the first carrier to be measured from the configured carriers according to the reference information, and performing measurement on the first carrier to be measured to determine the second carrier to be measured with the signal strength that satisfies the signal strength threshold, comprises:
determining all groups that comprise an unmeasured configured carrier, determining a group with a highest measurement priority, taking all configured carriers in the group as first carriers to be measured, and performing measurement on the first carriers to be measured to determine the second carrier to be measured with the signal strength that satisfies the signal strength threshold.

21. The communication apparatus according to claim 9, wherein, the enhanced EMR carrier measurement delay requirement comprises at least one of:
a measurement delay requirement for inter-frequency cells; or
a measurement delay requirement for inter-system cells.
